(19) United States
(12) Patent Application Publication
(10) Pub. No.: US 2014/0328384 A1
(43) Pub. Date: Nov. 6, 2014

(54) METHODS AND APPARATUSES INCLUDING A STATISTICAL MULTIPLEXER WITH GLOBAL RATE CONTROL

(71) Applicant: MAGNUM SEMICONDUCTOR, INC., Milpitas, CA (US)

(72) Inventor: Pavel Novotny, Waterloo (CA)

(73) Assignee: Magnum Semiconductor, Inc., Milpitas, CA (US)

(21) Appl. No.: 13/886,047

(22) Filed: May 2, 2013

(51) Int. Cl. H04N 19/115

(52) U.S. Cl. CPC H04N 19/0006
USPC 375/240.02

(57) ABSTRACT

Examples methods and apparatuses including a statistical multiplexer with global rate control are described herein. An example apparatus may include a statistical multiplexing (statmux) system coupled to a communication link. The statmux system includes a global rate controller and a plurality of encoders. Each encoder of the plurality of encoders may receive data from a respective channel of a plurality of channels. The global rate controller may buffer respective coding units of at least two of the plurality of channels and estimate respective sizes of buffered coding units of the buffered respective coding units. The global rate controller may provide a quality parameter to the plurality of encoders having a value based on the estimated coded sizes of the buffered coding units.

### TECHNICAL FIELD

Embodiments described relate to video encoding, and include a statistical multiplexer with global rate control to combine multiple channels.

### BACKGROUND

In content distribution environments, communication links may be created with each communication link having a fixed bandwidth. The fixed bandwidth of a communication link is typically higher than the bandwidth needs of any single channel of media content provided from a content provider. Thus, content providers may pool encoded bitstreams of several channels together to maximize use of the bandwidth of the communication link. Modern block based video coding standards such as MPEG2, H.261, H.262, H.263 and H.264 take advantage of temporal and spatial redundancy of a channel to achieve efficient video compression, but produce variable bitrate (VBR) bitstreams. As complexity of content of the channel changes, the bitrates of the encoded bitstreams may vary over time. A quantification of complexity is often specific to a video coding methodology and an encoder used to encode the content. One issue with pooling encoded bitstreams of several channels is managing the variability of the bitrates of each encoded bitstream to efficiently use bandwidth of a constant bitrate communication link while maintaining consistent video quality on each channel.

A conventional implementation of managing bandwidth of a pool of encoded bitstreams may use a statistical multiplexer (statmux) system. The statmux system may include several encoders, a controller, and a multiplexer. The inputs to the encoders may be content channels to be encoded for the purpose of content distribution. Encoded bitstreams are provided from the several encoders to a multiplexer. The multiplexer may combine the encoded bitstreams into a multi-program transport stream (MPTS). On the receiving side, one or more encoded bitstreams are de-multiplexed from the MPTS using standard de-multiplexing techniques and decoded. A statmux system may be beneficial in this scenario since it can pool multiple channels together in such a way that the final bitstream has a continuous bitrate, which may be distributed over existing distribution networks.

A typical way of controlling bitrates of the individual encoders in a statmux system is to divide time into time slots having fixed periods, and to divide the available bandwidth of the communication link for a time slot between the channels by assigning a bitrate to each channel. Each encoder is likely to be producing different bitrates at different times, and on average, if the complexity of the content on one channel increases, the complexity of another channel's content might be reduced in the same time. The encoders then use local rate controllers to encode content based on the assigned bitrates for a time slot and information about the content received by the individual controller implementing rate control without exceeding the given limits to avoid exceeding a bandwidth of the communication link for the time slot.

### BRIEF DESCRIPTION OF THE DRAWINGS

FIG. 1 is a block diagram of a content distribution system including a statmux system with a global rate controller according to an embodiment of the disclosure;

FIG. 2 is a block diagram of a content distribution system including a statmux system with a global rate controller according to an embodiment of the disclosure;

FIG. 3 is a block diagram of a content distribution system including a statmux system with a global rate controller according to an embodiment of the disclosure;

FIG. 4 is timing diagram of a data level of a virtual buffer verifier (VBV) buffer according to an embodiment of the disclosure;

FIG. 5 is a schematic illustration of a media delivery system according to an embodiment of the disclosure; and

FIG. 6 is a schematic illustration of a video distribution system that may make use of a media delivery system described herein.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

There may be potential complexities associated with the conventional statmux setup described above. One potential complexity is that the controller determines an assigned bitrate for each encoder for a respective current frame to be encoded, without considering the complexity of future frames to be encoded. If complexity varies significantly over the course of a series of frames, the quality of the encoded video content may be constantly changing at a rapid rate. Further, as explained above, the encoders may produce a variable bitrate bitstream based on complexity of the video data. Thus, for an assigned bitrate, a less complex frame may have noticeably better quality than a more complex frame. Using assigned bitrates to control rates of encoders may therefore result in noticeable changes in video quality.

Another potential complexity may result from a delay between when an encoder encodes some portion of the content based on the assigned bitrate and when the encoded bitstream containing the encoded portion actually appears on the output of the encoder. The delay may be variable, depending on the complexity of the content and the assigned encoding bitrate. For example, the variable delay may be based on a method used to control the rate of the encoders. Many standard rate control methodologies in encoders use a Virtual Buffer Verifier (VBV) buffer model. In the VBV buffer model, each encoder provides encoded frames to its own VBV buffer. The encoders may provide encoded frames of various sizes. Frames will be removed from the VBV buffer for transmission at a constant bitrate. Since data is output from the VBV buffer at a constant bit-rate, and sizes of frames put into the VBV buffer may vary in accordance with the encoding methodology and quality used to encode, an amount of data in the VBV buffer may rise and fall accordingly. The variable delay may be a function of the amount of data present in the VBV buffer (e.g., more data in the VBV buffer increases the delay from when the time data is provided to the buffer to the time it is removed at a constant bitrate). Thus, in addition to assigning a bitrate, the controller estimates when the encoded bitstream will be provided at an output without knowing the level of the respective VBV buffer. In some embodiments, the VBV buffer may be a physical buffer in which data may be stored, and in other embodiments the VBV buffer may not be a physical buffer but may represent a model of the amount of data available relative to the constant bitrate output.

Additionally, since each encoder in conventional schemes is assigned a fixed bit budget for a fixed time period (e.g., the assigned bitrate), an encoder may have to adjust a video quality to fit the media content to be encoded into the fixed bit budget. The adjustments made to meet the timing and encoding bitrate conditions may degrade the video and result in noticeably reduced video quality.

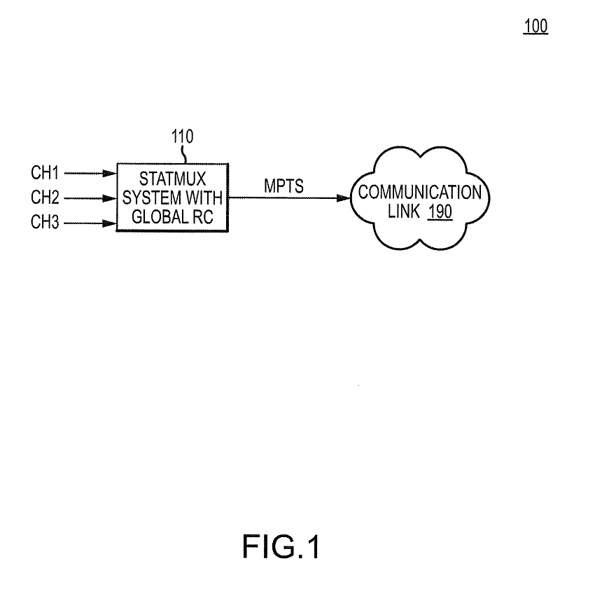

FIG. 1 is a block diagram of a content distribution system 100 including a statistical multiplexer (statmux) with a global rate controller (RC) 110 according to an embodiment of the disclosure. The content distribution system 100 may be implemented in hardware, software, firmware, or combinations thereof, and may include control logic, logic gates, processors, memory, and/or any combination or sub-combination of the same, and may be configured to encode and/or compress one or more CH0-N channels to provide one or more encoded bitstreams using one or more encoding techniques, and to pool the one or more encoded bitstreams into a multi-program transport stream (MPTS) to provide over a communication link 190.

The statmux with the global RC 110 may include one or more encoders and the global RC. As explained above, the statmux with the global RC 110 may receive coding units via the respective CH0-N channels, and to generate encoded bitstreams based on the coding units using one or more encoding techniques. Examples of coding units may include frames, sub-frames, regions, macroblocks, etc. In the interest of clarity, operation of the statmux with the global RC 110 will discussed in terms of frames as coding units. The encoded bitstreams may be variable bitrate bitstreams, with variance based on, for example, a complexity of the frames of content of the respective CH0-N channels. Examples of variables that may affect complexity may include spatial complexity of a frame of content of a channel (e.g., texture) and temporal complexity of a frame of content of a channel (e.g., motion complexities). The statmux with the global RC 110 may provide the MPTS to the communication link 190. The communication link 190 may have a fixed bandwidth.

In operation, the statmux with the global RC 110 may manage encoding and combining of the CH0-N channels into the MPTS to be transmitted over the communication link 190. Generally, the statmux with the global RC 110 may utilize global rate control to determine a quality level at which to encode each of the associated channels. Global rate control generally refers to the use of information about more than one channel in determining a quality at which to encode a single channel. By utilizing global rate control in a statmux, a constant bitrate stream may be developed based on coding units from multiple channels while reducing or minimizing the changes in quality occurring in any one channel.

The global RC may buffer coding units (e.g. frames) of each CH0-N channel for a length of time prior to encoding. The global RC may analyze the buffered frames to determine base statistical information for each buffered frame. The global RC may also receive statistical information regarding encoded coding units from an encoder associated with each CH0-N channel. The global RC may provide a quality parameter (QP) to each of the encoders having a value based on the base statistical information and the statistical information regarding encoded coding units. The quality parameter (QP) provided to each of the encoders may be based on statistical information from more than one channel, including more than just the channel with which the encoder is associated. The encoders may encode coding units of an associated CH0-N channel based on the provided QP and provide the encoded coding units in a respective encoded bitstream. The encoding methodologies for each encoder may result encoded frames of the respective CH0-N channel having variable bitrates. The statmux with the global RC 110 may combine the encoded bitstreams provided from each of the encoders into the MPTS and provide the MPTS at an output over the communication link 190.

In some embodiments, the statmux with the global RC 110 may include and/or be configured to model a global output buffer having a target constant bitrate output. In some embodiments the target constant bitrate output may be equal to a constant bitrate of the communications link 190. An amount of data present in (e.g. level of) the model output buffer may be changed in a first direction (e.g. may increase) based on actual encoded frame sizes of frames of the CH0-N channels, which may be included in the encoded statistical information, and may be changed in a second direction (e.g. may decrease) based on the target constant bitrate output. In some embodiments, the first direction is increasing and the second direction is decreasing. In other embodiments, the first direction is decreasing and the second direction is increasing. The global RC may further estimate coded sizes of the buffered frames based on the base statistical information, and, starting with an initial amount of data in (e.g., a present level of) the model output buffer, to estimate an amount of data in (e.g., a future level of) the model output buffer after encoding the buffered frames based on the estimated coded sizes of the buffered frames. The global RC may increase or decrease a value of the QP if the estimated amount of data in (e.g., the estimated future level of) the model output buffer is outside the output buffer level thresholds. In some embodiments, the minimum threshold may at least 50% of a size of the model output buffer, such as 65%. In some embodiments, the maximum threshold may be equal to or less than 95% of the size of the model output buffer.

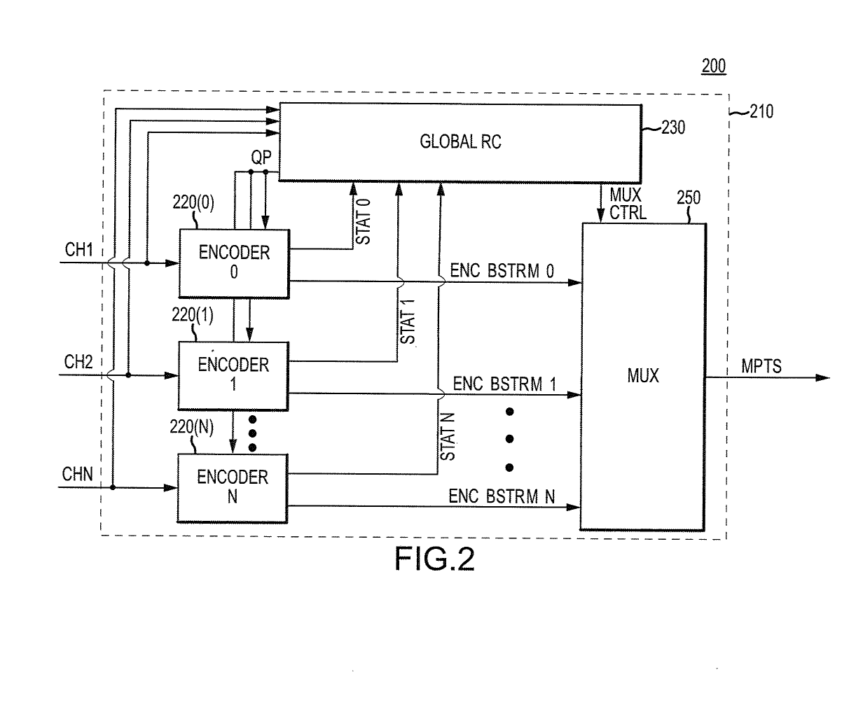

FIG. 2 is a block diagram of a statistical multiplexer (statmux) system 200 including a statmux with a global rate controller (RC) 210 according to an embodiment of the disclosure. The statmux with the global RC 210 may be implemented in hardware, software, firmware, or combinations thereof, and may include control logic, logic gates, processors, memory, and/or any combination or sub-combination of the same, and may be configured to encode and/or compress respective frames of the CH0-N channels to provide one or more encoded bitstreams 0-N using one or more encoding techniques, and to combine the encoded bitstreams 0-N into a multi-program transport stream (MPTS) signal. The statmux with the global RC 210 may be used to implement the statmux with the global RC 110 of FIG. 1.

The statmux with the global RC 210 may include the global RC 230. The global RC 230 may receive statistical information STAT 0-N associated with encoded coding units of the respective CH0-N channels from one or more of the encoders 0-N 220(0-N). As explained above, examples of coding units may include frames, sub-frames, regions, macroblocks, etc. In the interest of clarity, operation of the statmux with the global RC 210 will discussed in terms of frames as coding units. The STAT 0-N information may include information regarding encoded coding units, such as but not limited to, information indicating an actual size of an encoded frame, unquantized frame size, complexity information based on a quality parameter, or combinations thereof. The global RC 230 may further receive and buffer coding units (e.g. frames) of the CH0-N channels for a length of time in a lookahead buffer. The length of time may be associated with an I-frame period of a channel of the CH-N channels, a virtual buffer verifier buffer length of at least one encoder of the encoders 0-N 220(0-N), and/or a predetermined time, such as one second.

The global RC 230 may analyze the buffered frames to determine complexity information associated with the buffered frames. The global RC 230 may estimate a coded size of a buffered frame for a given quality parameter (QP) value based on the complexity of the buffered frame and based on any, some, or all of the STAT 0-N information associated with the respective CH0-N of the buffered frame. Using the STAT 0-N information, the global RC 230 may model a level (e.g. amount of data) of an output buffer based on the combined encoded bitstreams 0-N associated with the CH0-N channels. The model output buffer may have a target constant bitrate output. The target constant bitrate output may be equal to a constant bitrate of the communication link. Additionally, the global RC 230 may estimate (e.g. predict) a future level of the model output buffer after encoding the buffered frames based on the estimated sizes of the encoded buffered frames. The global RC 230 may provide a QP value to the encoders 0-N 220(0-N) having a value based on the estimated level of the model output buffer after encoding the buffered frames. For example, the global RC 230 may estimate the encoded size of coding units to be placed into the model output buffer using a selected QP value. If the estimated coded sizes, together with the constant bitrate removal of data from the model output buffer, causes the model output buffer to become too full relative to a threshold, a quality parameter resulting in an increased quality (and increased size) coding unit may instead be used. Similarly, if the estimated coded sizes, together with the constant bitrate removal of data from the model output buffer, causes the model output buffer to become too empty relative to a threshold, a quality parameter resulting in a reduced quality coding unit may instead be used.

The encoders 0-N 220(0-N) may receive respective coding units via the respective CH0-N channels and provide respective frames via the encoded bitstreams 0-N at an output of each of the respective encoders. The encoders may be implemented in hardware, software, or combinations thereof. The encoders 0-N 220(0-N) may include respective entropy encoders, such as a variable-length coding encoder (e.g., Huffman encoder, context-adaptive variable length coding (CAVLC) encoder, or context-adaptive binary arithmetic coding (CABAC) encoder), and/or may be configured to encode the frames, for instance, at a macroblock level. Each macroblock may be encoded in intra-coded mode, inter-coded mode, bidirectionally, or in any combination or subcombination of the same. As an example, the encoders 0-N 220(0-N) may receive and encode frames via the respective CH0-N channels. The respective CH0-N channels may be encoded in accordance with one or more encoding algorithms or standards, such as MPEG-2, MPEG-4, H.263, H.264, and/or HEVC. The encoding methodologies and/or standards implemented by each encoder 0-N 220(0-N) may result in encoded frames having variable bitrates. The encoders 0-N 220(0-N) may further provide the respective STAT 0-N information to the global RC 230. The respective STAT 0-N information may be based on a respective encoded frame.

The statmux with the global RC 210 may further include a multiplexer 250 configured to receive the encoded bitstreams 0-N from the respective encoders 0-N 220(0-N). The multiplexer 250 may combine the encoded bitstreams 0-N into the MPTS based on a control signal MUX CTRL received from the global RC 230, and to provide the MPTS to the communication link.

In an example operation, the global RC 230 may manage transmission of encoded bitstreams 0-N having variable bitrates via the MPTS over a communication link. The communication link may have a fixed bandwidth (e.g., and a constant bitrate). The global RC 230 may use a lookahead methodology to analyze buffered frames of the channels 0-N to select a QP value. The selected QP value provided to the encoders 0-N 220(0-N) may facilitate a constant bitrate output while reducing or minimizing the changes in quality in a given channel from frame to frame. For example, by considering statistics gathered from multiple channels in the rate control methodology used, overall quality may not need to vary as much over time. For example, the global RC 230 may model an output buffer having a target constant bitrate output associated with the constant bitrate of the communication link. A level of the model output buffer may be increased based on a size of an encoded frame received via the STAT 0-N information from the encoders 0-N 220(0-N) (e.g., increasing the level based on the actual encoded frame size), while bits are continuously output from the model output buffer at the target constant bitrate (e.g., decreasing the level of the model output buffer at the target constant bitrate). As will be described further, the global RC 230 may estimate (e.g. predict) a future level of the model output buffer. The predicted future level of the model output buffer may be based on the estimated coded sizes of the buffered frames, which may be based on a present level of the model output buffer, a current QP value, the STAT 0-N information, and respective base statistical information associated with the buffered frames. Based on the estimated future level of the model output buffer, the global RC 230 may select a QP value that maintains the estimate future level of the model output buffer within a target area. Examples of a target area may include between 65% and 90% full. The QP value may be provided to the encoders 0-N 220(0-N). In some embodiments, estimating the model output buffer level to select a QP value repeats at least after encoding of each frame by the encoders 0-N 220(0-N).

Each of the respective encoders 0-N 220(0-N) may receive respective frames via the corresponding CH0-N channel. The frames of the CH0-N channels may be delayed via a respective delay buffer before receipt at a respective encoder 0-N 220(0-N) by a length of the lookahead buffer of the global RC 230. Responsive to receipt of respective frames, the encoders 0-N 220(0-N) may encode the received respective frames based on the QP value selected by the global RC 230. In some examples, the global RC 230 may select a single QP value for use by all or multiple encoders. In other examples, the global RC 230 may provide different QP values to different ones of the encoders. For example, if some channels require a certain minimum quality, the QP value provided to those encoders may be adjusted to ensure the minimum quality is met, while other channels may receive a QP value that may result in a lower quality encoded frame. The encoded frames may be provided in the respective encoded bitstreams 0-N to the multiplexer 250. The multiplexer 250 may time multiplex the encoded bitstreams 0-N into the MPTS based on the MUX CTRL signal.

Responsive to encoding each respective frame, the associated encoder 0-N 220(0-N) may provide updated respective STAT 0-N information to the global RC 230. Examples of STAT 0-N information associated with a respective frame may include an actual encoded frame size, complexity information, un-quantized encoded frame size information, and combinations thereof.

Responsive to receiving the updated STAT 0-N information from the respective encoder 0-N 220(0-N), the global RC 230 may perform a QP selection process. During the QP selection process, the global RC 230 may update a level of the model output buffer based on an actual size of an encoded frame received in the updated STAT 0-N information. Further, the global RC 230 may analyze the buffered frames of each CH0-N channel to determine a complexity, which may be based on a respective frame type (e.g., an intra-coded frame or an inter-coded frame). Based on the estimated complexity of each buffered frame and a QP value, the global RC 230 may also estimate a coded size of each buffered frame in the lookahead buffer.

Responsive to estimating the coded size of each buffered frame in the lookahead buffer, the global RC 230 may estimate a future level of the model output buffer starting with the present level of the model output buffer. For example, the global RC 230 may estimate a future level of the model output buffer using the estimated coded sizes of the buffered frames by sequentially adding the estimated coded sizes for each of the buffered frames to the present level. The estimated future level of the model output buffer at any given time may accordingly be modeled by the global RC 230 by adding the estimated coded sizes of the buffered frames in accordance with the relative timing of the buffered frames, and subtracting data at the target constant bitrate output. Based on the estimated future level of the model output buffer, the global RC 230 may adjust the QP value to maintain the estimated future buffer level within minimum and maximum thresholds (e.g., within a target area). As explained above, examples of minimum and maximum thresholds may be 65% and 90%, respectively, of the model output buffer size. The minimum and maximum thresholds defining the target area may be configurable and, for example, may be stored in a memory accessible to the global RC 230.

The above example operation is provided for illustrative purposes, and is not intended to limit the disclosure. As explained above, while the description of operation the statmux with the global RC 210 is based on encoding of frames, it will be appreciated that operation of the statmux system 200 may be based on encoding of coding units, such as macroblocks, and/or other sub-coding units, such as portions of a frame, and the encoded coding units or encoded sub-coding units may be provided to the mux 250 via the respective encoded bitstreams 0-N. It will be appreciated that, while FIG. 2 depicts three encoders, a statmux with the global RC 210 may include 2, or more than three encoders. The encoders 0-N 220(0-N) may have different architecture and/or may encode the frames of the respective CH0-N channels using different encoding methodologies or standards, and may operate at different rates. In some embodiments, the global RC 230 may operate at least as fast as a channel of the CH0-N channels having a fastest frame rate. It will be appreciated that encoding of channels may include other dependencies beyond bitrates and timing.

Further, it will also be appreciated that the global RC 230 may provide a different QP to each of the encoders 0-N 220(0-N). For example, the QPs may be assigned as follows: (1) QP deltas can be applied to individual channels of the CH0-N to introduce quality differences between the individual channels (e.g., premium channels with higher quality may be guaranteed a QP that achieves a quality a predetermined amount greater than one or more other channels); (2) fixing a QP for one or more of the CH0-N channels (e.g., a guaranteed quality of the one or more channels); (3) assigning minimum and maximum quality limits for one or more channels, which may be a more reliable way than specifying minimum and maximum bitrates, in some examples; (4) using non-linear quality control to limit changing a QP value for a particular channel or channels relative to changing QP for other channels; and (5) quality balancing between different encoders 0-N 220(0-N) of the same and different compression formats and different encoder's configurations within the statmux system 200.

The statmux with the global RC 210 may simplify operation of the encoders 0-N 220(0-N) as compared with conventional statistical multiplexing systems that require bitrates and timing from the encoders to be strictly individually controlled. Further, employing the look-ahead methodology in selection of a quality parameter may result in a more stable QP value, and thus, more consistent video quality of the channels,

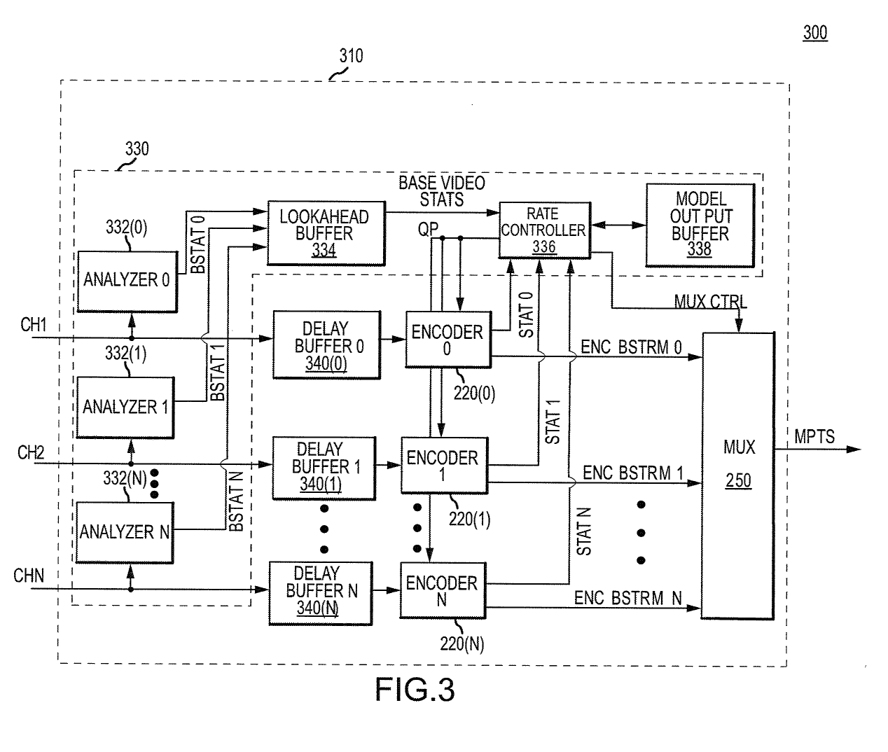

FIG. 3 is a block diagram of a statistical multiplexer (statmux) system 300 including a statmux with a global rate controller (RC) 310 according to an embodiment of the disclosure. The statmux with the global RC 310 may be implemented in hardware, software, firmware, or combinations thereof, and may include control logic, logic gates, processors, memory, and/or any combination or sub-combination of the same, and may be configured to encode and/or compress respective frames of the CH0-N channels to provide one or more encoded bitstreams 0-N using one or more encoding techniques, and to combine the encoded bitstreams 0-N into a multi-program transport stream (MPTS) signal. The statmux with a global rate controller (RC) 310 includes elements that have been previously described with respect to the statmux with a global rate controller (RC) 210 of FIG. 2. Those elements have been shown in FIG. 3 using the same reference numbers used in FIG. 2 and operation of the common elements is as previously described. Consequently, a detailed description of the operation of these elements will not be repeated in the interest of brevity. The statmux with the global RC 310 may be used in the statmux with the global RC 110 of FIG. 1 and/or the statmux with the global RC 210 of FIG. 2.

The statmux with the global RC 310 may include the global RC 330. The global RC 330 may include video analyzers 0-N 332(0-N) coupled to a lookahead buffer 334. The global RC 330 may further include a rate controller 336 coupled to the lookahead buffer 334. The rate controller 336 may be coupled to a model output buffer 338. The model output buffer 338 may be a physical buffer or may be a software model including a representation of an amount of data contained in (e.g., a level of) a modeled buffer. The video analyzers 0-N 332(0-N) may receive respective coding units via corresponding CH0-N channels. As explained with reference to FIG. 2, examples of coding units may include frames, sub-frames, regions, macroblocks, etc. In the interest of clarity, operation of the statmux with the global RC 310 will discussed in terms of frames as coding units. The video analyzers 0-N 332(0-N) may analyze the received frames of the CH0-N channels to determine complexity information and scene change information associated with each received frame. The video analyzers 0-N 332(0-N) may provide respective base statistical information and frames BSTAT 0-N to the lookahead buffer 334. The BSTAT 0-N information may include, for example, the complexity information and scene change information associated with each frame. Any suitable techniques for developing complexity information and scene change information may be used.

The lookahead buffer 334 may receive and buffer the BSTAT 0-N information associated with each of the CH0-N channels. The lookahead buffer 334 may buffer the BSTAT 0-N information for a length of time. In some embodiments, the length of time may be associated with an I-frame period, a virtual buffer verifier buffer length of at least one encoder of the encoders 0-N 220(0-N) or the length of the model output buffer 338, and/or a predetermined amount of time, such as one second. The lookahead buffer 334 may provide base statistical information associated with the buffered frames to the rate controller 336.

The rate controller 336 may receive statistical information STAT 0-N associated with encoded frames of the respective CH0-N channels from one or more of the encoders 0-N 220(0-N). The STAT 0-N information may include information indicating an actual size of an encoded frame, quantization information based on a quality parameter, or combinations thereof. The rate controller 336 may estimate a size of an coded buffered frame included in the lookahead buffer 334 for a given QP based on the complexity information associated with the buffered frame and based on the STAT 0-N information associated with the respective CH0-N channel of the buffered frame. Further, based on the STAT 0-N information, the rate controller 336 may update a level of the model output buffer 338 by adding actual encoded frames sizes to the model output buffer 338.

The model output buffer 338 may model an output buffer having a target constant bitrate. In some embodiments, the target constant bitrate may equal a constant bitrate of the communication link. A level of the model output buffer may be increased based on a size of an encoded frame received via the STAT 0-N information from the encoders 0-N 220(0-N) (e.g., changing the level in a first direction based on the actual encoded frame size), while bits are continuously output from the buffer at the target constant bitrate (e.g., changing the level of the model output buffer in a second direction at the constant bitrate). In some embodiments, the first direction is increasing the level and the second direction is decreasing the level. In other embodiments, the first direction is decreasing the level and the second direction is increasing the level. The model output buffer 338 may provide a present level to the rate controller 336. Additionally, based on the present level of the model output buffer 338, the rate controller 336 may estimate (e.g. predict) a future level of the model output buffer 338 after encoding the buffered frames based on the estimated sizes of the encoded buffered frames stored at the lookahead buffer 334. The rate controller 336 may provide a quality parameter QP to the encoders 0-N 220(0-N) having a value based on the estimated level of the model output buffer 338. Generally, the rate controller 336 may select a QP which results in the estimated future level of the model output buffer 338 staying within a target range (e.g. not filled over a maximum threshold and not depleted below a minimum threshold). By utilizing statistics from more than one channel, the rate controller's selection of QP and changes in QP may result in an overall improved quality across channels. Moreover, the use of lookahead buffer 334 may allow the rate controller 336 to make less drastic changes in the QP between coding units, including across scene changes. For example, if coding units on the CH1 channel are experiencing a low complexity while the coding units on the CH2 channel are of a higher complexity, the rate controller 336 may select a QP which does not reduce the quality of the higher complexity the CH2 channel coding units as much as would be needed if the controller was not aware of the lower complexity coding units being received at the CH1 channel. Because the rate controller 336 is able to utilize the size of all coded frames across channels in estimating the buffer 338 level, consistency in quality across channels may be improved relative to conventional systems that assign a bit rate to a single encoder without benefit of information about coding units received at other channels. Further, because the rate controller 336 provides a QP value to the encoders 0-N 220(0-N), a likelihood of video quality problems in the encoded bitstreams 0-N stemming from issues with the rate controller 336 is reduced as compared to a rate controllers that provide assigned bitrates to the encoders.

The frames of the CH0-N channels may be delayed to the respective encoders 0-N 220(0-N) via a respective delay buffer 0-N 340(0-N). A length of each of the delay buffers 0-N 340(0-N) may be equal to a length of the lookahead buffer 334. In this manner, the QP provided by the rate controller 336 using the information in the lookahead buffer 334 is appropriate for the frames arriving at the encoder 220 following delay by the respective delay buffer 0-N 340(0-N).

In an example operation, the global RC 330 may manage transmission of encoded bitstreams 0-N having variable bitrates via the MPTS over a communication link. The communication link may have a fixed bandwidth (e.g., and a constant bitrate). The global RC 330 may use a lookahead methodology to analyze the buffered frames in order to select a QP value that is to be provided to the encoders 0-N 220(0-N). For example, model output buffer 338 may store an amount of data influenced by the target constant bitrate output associated with the constant bitrate of the communication link. As explained above, the level of the model output buffer 338 may be increased based on a size of an encoded frames received from the lookahead buffer 334 via the STAT 0-N information from the encoders 0-N 220(0-N) (e.g., the level increases by the encoded frame size), while bits are continuously removed from the model output buffer 338 at the target constant bitrate. As will be described further, the rate controller 336 may estimate (e.g. predict) a future level of the model output buffer 338 after encoding the buffered frames in the lookahead buffer 334 based on a present level of the model output buffer 338, a current QP, the STAT 0-N information, and base statistical information corresponding to the buffered frames received from the lookahead buffer 334. Based on the estimated future level of the model output buffer 338, the rate controller 336 may select a QP value that maintains the estimated future level of the model output buffer 338 within a target area. Examples of a target area may include estimated future level of the model output buffer 338 being between 65% and 90% full. The QP value may be provided to the encoders 0-N 220(0-N). In some embodiments, estimating the future level of model output buffer 338 to select the QP value repeats responsive to receiving updated STAT 0-N information from one or more of the encoders 0-N 220(0-N).

Each of the respective encoders 0-N 220(0-N) may receive respective frames of the corresponding CH0-N channel via the respective delay buffer 340 0-N 340(0-N). Responsive to receipt of respective frames, the encoders 0-N 220(0-N) may encode the respective received frames based on the QP value selected by the rate controller 336. The encoded frames may be provided in the respective encoded bitstream 0-N to the multiplexer 250. The multiplexer 250 may time multiplex the encoded bitstreams 0-N into the MPTS based on the MUX CTRL signal from the rate controller 336.

Responsive to encoding each respective frame, the associated encoder 0-N 220(0-N) may provide respective updated STAT 0-N information to the rate controller 336. Examples of STAT 0-N information associated with a respective frame may include an actual encoded frame size, a score, and/or a coded-ratio. The score may indicate complexity of a frame. For example, in an intra-coded frame, the score may indicate the intra complexity (e.g., spatial complexity, such as texture) of a frame. In an inter-coded frame, the score may indicate the smaller of the intra complexity (e.g., spatial complexity, such as texture) or the inter complexity (e.g., temporal complexity, such as motion complexity) of the frame. The coded-ratio may indicate a ratio of an unquantized encoded frame size to a given frame complexity (e.g., score). In an embodiment, the coded-ratio for an M channel of the CH0-N channels and a frame type (e.g., an intra-coded frame or an inter-coded frame) may be calculated as follows

Coded-Ratio_{M}[frame type]=Frame_Coded_Size_{M}*quant_{M}[QP]/score_{MJ},

where frame type indicates a coded-ratio for an intra-coded frame or an inter coded frame, Frame_Coded_Size_{M} represents an actual encoded frame size after quantization for a M channel of the CH0-CHN channels, and quant[QP] represents a format specific value used in the encoding process for the M channel based on the QP. In other embodiments, a coded-ratio value may be an average or smoothed encoded sizes of multiple frames of a respective CH0-N channel (e.g., such as frames of a scene). In some embodiments, the rate controller 336 may receive the coded-ratios from multiple encoders to which the rate controller 336 is in communication (e.g., via the STAT 0-N information from the encoders 0-N 220(0-N)) associated with a frame of their respective CH0-N channel. In other embodiments, the rate controller 336 may generate a coded-ratio for each of the CH0-N channels based on the associated STAT 0-N information.

Responsive to receiving the updated STAT 0-N information, the rate controller 336 may perform a QP selection operation. The QP selection operation may include the rate controller 336 providing an actual size of the encoded frame included in the updated STAT 0-N information to the model output buffer 338. The model output buffer 338 may update the buffer level based on the actual size of an encoded frame received from the rate controller 336.

As explained above, the analyzers 0-N 332(0-N) may generate respective BSTAT 0-N information based on frames received via a respective CH0-N channel. Further, the received frames may be included in the BSTAT 0-N information. For example, the analyzers 0-N 332(0-N) may determine a complexity (e.g., a score) based on a frame type (e.g., an intra-coded frame or an inter-coded frame) of each respective received frame. In some embodiments, the analyzers 0-N 332(0-N) may be first pass encoders that encode the frames of the respective CH0-N channel, and the BSTAT 0-N information may be based on the first pass encoding. The first pass encoders encode the frames of the respective CH0-N channel based on an internal constant bitrate control, a QP value provided by the rate controller 336, or a fixed QP value. The analyzers 0-N 332(0-N) may further detect scene change information in each of the respective received frames. The lookahead buffer 334 may buffer the BSTAT 0-N information.

The QP selection operation performed by the rate controller 336 may include retrieving statistical information associated with each buffered frame from the lookahead buffer 334 to estimate an encoded size of each buffered frame. For example, the rate controller 336 may estimate the coded size for the buffered frame of a respective channel of the CH0-N channels based on the estimated complexity of the buffered frame, the coded-ratio for the associated CH0-N channel, and a current QP value. In some embodiments, the estimated buffered coded frame size for the i^{th} buffered frame on the M^{th} M channel may be calculated as follows

Est_Frame_Coded_Size_{Mi}=score_{Mi}*coded_ratio_{M}[frame type]/quant_{M}[QP],

where score_{Mi} is the complexity score for the i^{th} frame (e.g., the intra-complexity if i^{th} frame is an intra-coded frame and the minimum of the intra-complexity and the inter-complexity if the i^{th} frame is an inter-coded frame), coded_ratio_{M} [frame type] is a coded-ratio for the frame type of M channel, and quant_{M}[QP] represents a format specific value used in the encoding process for the M channel based on the QP.

As explained, the coded-ratio of the respective STAT 0-N information may correspond to a most recently encoded frame of a respective CH0-N channel. Often, a scene includes a group of frames, and, generally, frames of the same scene may be estimated to have a similar coded-ratio, with slight variations. Thus, the coded-ratio may be used to estimate a coded size of buffered frames of the same scene as the most recently encoded frame for a CH0-N channel. However, frames of another scene may have different coded-ratios. The rate controller 336 may detect a scene change frame of the buffered frames associated with a CH0-N channel based on scene change information included in the base statistical information retrieved from the lookahead buffer 334. Based on detection of a scene change frame, the rate controller 336 may use a default coded-ratio to determine the estimated frame coded size starting with the scene change frame through the remaining buffered frames stored at the lookahead buffer 334 that are associated with the respective CH0-N channel. Once those frames have been considered by the encoders 0-N 220(0-N), a new coded-ratio may be calculated for the next scene. In this manner, buffered frames from the next scene may be utilized by the rate controller 336 even before the next coded-ratio has been calculated by the encoders 0-N 220(0-N) and/or the rate controller 336 for the next scene.

During the QP selection process, starting with the present level of the model output buffer 338, the rate controller 336 may estimate a future level of the model output buffer 338 after the buffered frames of the lookahead buffer 334 have been encoded. For example, the estimated future level may be determined by the rate controller 336 by sequentially adding the estimated frame coded sizes for each of the buffered frames to the present level based on relative timing of the buffered frames, while bits are removed from the model output buffer 338 at the target constant bitrate output. Based on the estimated future level of the model output buffer 338, the rate controller 336 may adjust the QP value to maintain the estimated future level of the model output buffer 338 within minimum and maximum thresholds (e.g., the target area). As explained above, examples of minimum and maximum thresholds may be 65% and 90%, respectively, of the model output buffer 338 size.

The rate controller 336 may use a previous QP value for an initial iteration of the QP selection process. If the rate controller 336 detects that a previous QP value will result in the estimated future level of the model output buffer 338 being within the target area, the rate controller 336 may select the previous QP value. If the rate controller 336 detects that a previous QP value will result in the estimated future level of the model output buffer 338 exceeding the target area (e.g., indicating that the encoders 0-N 220(0-N) may not be producing enough data), the rate controller 336 may decrease the QP value (e.g., increase the quality) and the rate controller 336 may perform another iteration of the QP selection process. If the rate controller 336 detects that a previous QP value will result in the estimated future level of the model output buffer 338 being below the target area (e.g., indicating that the encoders 0-N 220(0-N) may be producing too much data), the rate controller 336 may increase the QP value (e.g., decrease the quality) and the rate controller 336 may perform another iteration of the QP selection process.

During the QP selection process, an estimated future level of the model output buffer 338 may be within the target area of the model output buffer 338, but the rate controller 336 may estimate that the model output buffer 338 will underflow (e.g., the level of the model output buffer 338 contains less than zero bits of data) or overflow (e.g., the level exceeds a maximum level of the model output buffer 338) at some point along the estimation timeline. The rate controller 336 may be configured to attempt to prevent an underflow or an overflow event. If the rate controller 336 is unable to select a QP value that avoids the underflow or overflow event, the rate controller 336 may be configured to delay the underflow or overflow event as long as possible. For example, if, during the QP selection process, the rate controller 336 detects that the previous QP value will result in an under flow or an overflow event at any point, and a previous iteration of the QP selection process did not produce an underflow or overflow event, the rate controller 336 may select the previous QP value. If, during both the previous and current QP selection processes, the rate controller 336 detected an underflow or an overflow event using the previous QP value at any point, and a first point of contact in time causing the underflow/overflow event during the previous iteration of the QP selection process is further in time (e.g., later) that the first point of contact in time in the current QP selection process, the rate controller 336 may select the previous QP value. Otherwise, the rate controller 336 may select a new QP value.

The above example operation is provided for illustrative purposes, and is not intended to limit the disclosure. As explained above, while the description of operation of the statmux with the global RC 310 is based on encoding of frames, it will be appreciated that operation of the statmux system 300 may be based on buffering and encoding of coding units, such as macroblocks, and/or other sub-coding units, such as portions of a frame, and the encoded coding units or encoded sub-coding units are provided to the multiplexer 250 via the respective encoded bitstreams 0-N. It will be appreciated that, while FIG. 3 depicts three encoders, a statmux with the global RC 310 may include 2, or more than three encoders. The encoders 0-N 220(0-N) may have different architecture and/or may encode the frames of the respective CH0-N channels using different encoding methodologies or standards, and may operate at different rates. In some embodiments, the elements of the global RC 330 may operate at a rate least as great as a frame (e.g., or coding unit) rate of a channel of the CH0-N channels having a highest frame (e.g., or coding unit) rate. Increasing a number of channels received by the statmux system 300 reduces an amount of statistical data necessary from any single CH0-N. Thus, in some embodiments, the length of the lookahead buffer 334 may be reduced as the number of channels increases. Further, in embodiments where the CH0-N channels include both high latency channels (e.g., coupled to encoders that include 0.5-1 second look ahead buffers) and low latency channels (e.g., coupled to encoders that include equal to or less than 0.1 second lookahead buffers), when enough of the high latency channels are present to estimate the level of the model output buffer 338, one or more of the low latency channels may bypass the respective analyzers 0-N 332(0-N) and the lookahead buffer 334, and be provided directly to the respective encoders 0-N 220(0-N). Allowing one or more low latency channels to bypass the respective analyzers 0-N 332(0-N) and the lookahead buffer 334 may preserve the low latency characteristic of the one or more low latency channels.

Further, it will be appreciated that the logical connections between elements of the statmux with the global RC 310 may vary from the connections depicted in FIG. 3. For example, the actual encoded frame size may be provided directly to the model output buffer 338, rather than being provided via the rate controller 336. Further, BSTAT 0-N information may only include complexity and other statistical information from the analyzers 0-N 332(0-N), and the frames of the CH0-N may be provided directly to the lookahead buffer 334, rather than through the analyzers 0-N 332(0-N). It will be appreciated that encoding of channels may include other dependencies beyond bitrates and timing.

The statmux with the global RC 310 may simplify operation of the encoders 0-N 220(0-N) as compared with conventional statistical multiplexing systems that require bitrates and timing from the encoders to be strictly controlled. Further, employing the look-ahead methodology in selection of a quality parameter may result in a more stable QP value, and thus, more consistent video quality of the channels.

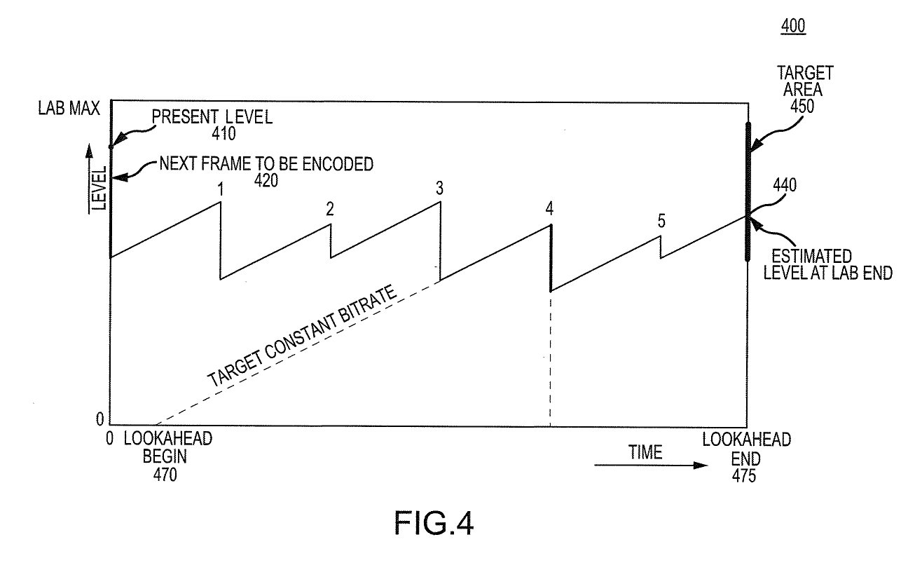

FIG. 4 is an exemplary timing diagram of an estimation of a level of a model output buffer as described with reference to FIGS. 1-3. In the exemplary timing diagram 400, the horizontal axis represents time and the vertical axis represents a level of the model output buffer (e.g. an amount of data in the model buffer). The left vertical axis represents a lookahead begin time 470 (e.g., a current time) and the right vertical axis represents a lookahead end time 475, with a distance between the lookahead begin time 470 and the lookahead end time 475 representing a lookahead duration. The lookahead duration may represent a length of a lookahead buffer, such as the lookahead buffer 334 of FIG. 3. The exemplary timing diagram 400 is depicted from a perspective of a decoder. Thus, rather than depicting new frames filling the model output buffer, new frames are instantaneously pulled/removed from the model output buffer (e.g., to be decoded). Further, rather that the model output buffer being drained the target constant bitrate, the model output buffer is filled at the target constant bitrate. The estimation of the model output buffer depicted in the exemplary timing diagram 400 may be performed by the statmux with global RC 110 of FIG. 1, the global RC 230 of FIG. 2, and/or the rate controller 336 of FIG. 3.

In the exemplary timing diagram 400, the present level 410 is depicted at the lookahead begin time 470. At the lookahead begin time 470, a next frame to be encoded 420 is pulled/removed from the model output buffer, with a size of the vertical drop in the exemplary timing diagram 400 equal to an estimated size of the next frame to be encoded 420. After the next frame to be encoded 420 is pulled/removed from the model output buffer, the level of the model output buffer may increase at a target constant rate (e.g., represented by a constant slope). This constant rate may represent the target constant bitrate at which the model output buffer is filled. As the exemplary timing diagram 400 progresses from the lookahead begin time 470 to the lookahead end time 475, data representing 5 additional frames are pulled/removed from the model output buffer, as indicated by numbers 1-5. A size of a vertical drop corresponding to the frames 1-5 indicates an estimated size of the frames. Between removal of each frame, the level of the model output buffer increases at the target constant bitrate. At the lookahead end time 475, the estimated level 440 may be used to select a QP value. If the estimated level 440 is within the target area 450, then the current QP value may be used. If the estimated level 440 is outside the target area, the QP value may be increased or decreased and a new estimated level 440 may be determined. If at any point along the estimation, the estimated level of the buffer exceeds the maximum size of the model output buffer LAB MAX (e.g., overflow), or if the estimated level becomes a negative value (e.g., underflow), the global RC may select a QP value that prevents the overflow or underflow event. If the overflow or underflow event cannot be prevented, the global RC may select a QP value that pushes the overflow or underflow event to the latest point in time.

It will be appreciated that, while the exemplary timing diagram 400 depicts estimating the level of the model output buffer based on six buffered frames, estimating the level of the model output buffer may be based on more or less than six buffered frames. Further, the sizes of the frames in the exemplary timing diagram 400 are for illustrative purposes, and actual buffered frame sizes may vary. It will be appreciated that the target area is illustrative, and may be larger or smaller than depicted. Further, the constant bitrate may be any bitrate, such as a constant bitrate of an associated communication link.

Components described herein, including but not limited to the statmux systems, rate controllers, and encoders described herein, may be implemented in all or in part using software in some examples. The software may be implemented using instructions encoded on one or more computer readable media. Any electronic storage (e.g. memory) may be used to implement the computer readable media, which may be transitory or non-transitory. The computer readable media may be encoded with instructions for performing the acts described herein, including but not limited to, rate control, encoding, QP selection, buffering, and combinations thereof. The instructions may be executable by one or more processing units to perform the acts described. The processing units may be implemented using any number and type of hardware capable of executing the instructions including, but not limited to, one or more processors, circuitry, or combinations thereof.

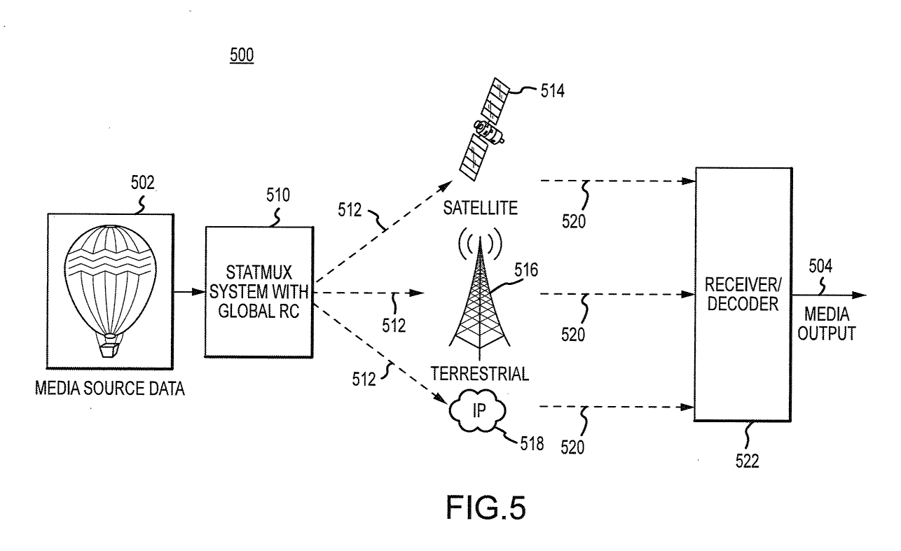

FIG. 5 is a schematic illustration of a media delivery system 500 in accordance with embodiments. The media delivery system 500 may provide a mechanism for delivering a media source 502 to one or more of a variety of media output(s) 504. Although only one media source 502 and media output 504 are illustrated in FIG. 5, it is to be understood that any number may be used, and examples may be used to broadcast and/or otherwise deliver media content to any number of media outputs.

The media source data 502 may be any source of media content, including but not limited to, video, audio, data, or combinations thereof. The media source data 502 may be, for example, audio and/or video data that may be captured using a camera, microphone, and/or other capturing devices, or may be generated or provided by a processing device. Media source data 502 may be analog or digital. When the media source data 502 is analog data, the media source data 502 may be converted to digital data using, for example, an analog-to-digital converter (ADC). The media source data 502 may represent several channels of media source data. Typically, to transmit each channel of the media source data 502, some type of compression and/or encryption may be desirable, with the compressed/encrypted channels being distributed over a common link. Accordingly, a statistical multiplexer with a global rate controller (RC) 510 may be provided that may encode each channel of the media source data 502 using any encoding method in the art, known now or in the future, including encoding methods in accordance with video standards such as, but not limited to, MPEG-2, MPEG-4, H.264, HEVC, or combinations of these or other encoding standards.

The statistical multiplexer with the global RC 510 may combine encoded data of each channel of the media source data 502 based on a bandwidth of a communication link and to provide the combined encoded data 512 over a communications link. Examples of communications links may include a satellite 514, an antenna 516, and/or a network 518. The statistical multiplexer with the global RC 510 may be implemented using any statistical multiplexer with global RC described herein, including the statistical multiplexer with the global RC 110 of FIG. 1, the statistical multiplexer with the global RC 210 of FIG. 2, and/or the statistical multiplexer with the global RC 310 of FIG. 3. The network 518 may be wired or wireless, and further may communicate using electrical and/or optical transmission. The antenna 516 may be a terrestrial antenna, and may, for example, receive and transmit conventional AM and FM signals, satellite signals, or other signals known in the art. The communications communication link may broadcast the combined encoded data 512, and in some examples may alter the combined encoded data 512 and broadcast the altered combined encoded data 512 (e.g., by re-encoding, adding to, or subtracting from the combined encoded data 502). The combined encoded data 520 provided from the communications communication link may be received by a receiver 522 that may include or be coupled to a decoder. The decoder may decode the combined encoded data 520 to provide one or more media outputs, with the media output 504 shown in FIG. 5.

The receiver 522 may be included in or in communication with any number of devices, including but not limited to a modem, router, server, set-top box, laptop, desktop, computer, tablet, mobile phone, etc.

The media delivery system 500 of FIG. 5 and/or the statistical multiplexer with the global RC 510 may be utilized in a variety of segments of a content distribution industry.

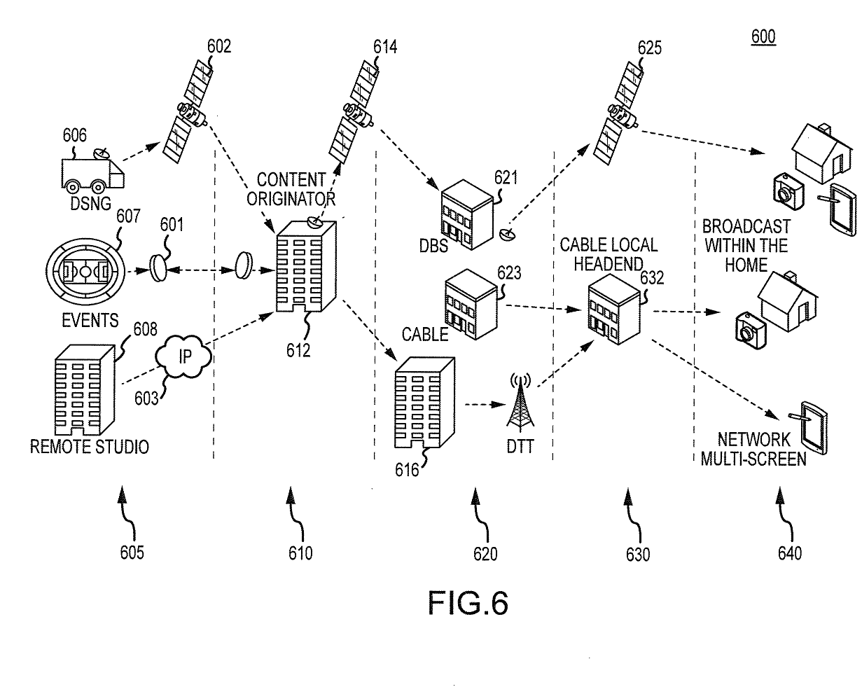

FIG. 6 is a schematic illustration of a video distribution system that 600 may make use of encoders described herein. The video distribution system 600 includes video contributors 605. The video contributors 605 may include, but are not limited to, digital satellite news gathering systems 606, event broadcasts 607, and remote studios 608. Each or any of these video contributors 605 may utilize statistical multiplexers with global RC described herein, such as the statistical multiplexer with the global RC 510 of FIG. 5, to encode and combine multiple channels of media source data and provide combined channel encoded data to a communications link. The digital satellite news gathering system 606 may provide combined channel encoded data to a satellite 602. The event broadcast 607 may provide combined channel encoded data to an antenna 601. The remote studio 608 may provide combined channel encoded data over a network 603.

A production segment 610 may include a content originator 612. The content originator 612 may receive combined channel encoded data from any or combinations of the video contributors 605. The content originator 612 may make the received content available, and may edit, combine, and/or manipulate any of the received content to make the content available. The content originator 612 may utilize statistical multiplexers with global RC described herein, such as the statistical multiplexer with the global RC 510 of FIG. 5, to provide combined channel encoded data to the satellite 614 (or another communications link). The content originator 612 may provide combined channel encoded data to a digital terrestrial television system 616 over a network or other communication link. In some examples, the content originator 612 may utilize a decoder to decode the content received from the contributor(s) 605. The content originator 612 may then re-encode and combine data; potentially utilizing statistical multiplexers with global RC described herein, such as the statistical multiplexer with the global RC 510 of FIG. 5, and provide the combined channel encoded data to the satellite 614. In other examples, the content originator 612 may not decode the received data, and may utilize a transcoder (which may include of an encoder of the statistical multiplexer with the global RC 510 of FIG. 5) to change an encoding format of the received data.

A primary distribution segment 620 may include a digital broadcast system 621, the digital terrestrial television system 616, and/or a cable system 623. The digital broadcasting system 621 may include a receiver, such as the receiver 522 described with reference to FIG. 5, to receive combined channel encoded data from the satellite 614. The digital terrestrial television system 616 may include a receiver, such as the receiver 522 described with reference to FIG. 5, to receive combined channel encoded data from the content originator 612. The cable system 623 may host its own content which may or may not have been received from the production segment 610 and/or the contributor segment 605. For example, the cable system 623 may provide its own media source data 502 as that which was described with reference to FIG. 5.

The digital broadcast system 621 may include an encoder, such as the statistical multiplexer with the global RC 510 of FIG. 5, to provide encoded data to the satellite 625. The cable system 623 may include a statistical multiplexer with VBV shifter, such as the statistical multiplexer with the global RC 510 of FIG. 5 as described with reference to FIG. 5, to provide combined channel encoded data over a network or other communications communication link to a cable local headend 632. A secondary distribution segment 630 may include, for example, the satellite 625 and/or the cable local headend 632.

The cable local headend 632 may include a statistical multiplexer with global RC, such as the statistical multiplexer with the global RC 510 of FIG. 5, to provide combined channel encoded data to clients in a client segment 640 over a network or other communications link. The satellite 625 may broadcast signals to clients in the client segment 640. The client segment 640 may include any number of devices that may include receivers, such as the receiver 522 and associated decoder described with reference to FIG. 5, for decoding content, and ultimately, making content available to users. The client segment 640 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus, comprising:
a statistical multiplexing (statmux) system coupled to a communication link, the statmux system comprising a global rate controller and a plurality of encoders, wherein an encoder of the plurality of encoders is configured to receive a respective channel of a plurality of channels, the global rate controller configured to buffer respective coding units received on at least two of the plurality of channels, the global rate controller further configured to estimate a respective coded size of the buffered respective coding units, the global rate controller configured to provide a quality parameter to the plurality of encoders having a value based on the estimated coded sizes of the buffered respective coding units.

2. The apparatus of claim 1, wherein an encoder of the plurality of encoders associated with the channel is configured to encode respective coding units of the channel based on the quality parameter and to provide the encoded coding units in a respective coded bitstream at an output, wherein the global rate controller is configured to receive statistical information from the encoder, and wherein the estimated coded size of the buffered coding unit is based on the statistical information.

3. The apparatus of claim 2, wherein the statistical information includes a size of an encoded coding unit of the coding units and a coded-ratio, wherein the coded-ratio is a ratio of an unquantized size of the coding unit to a complexity of the coding unit.

4. The apparatus of claim 2, wherein the statmux system further comprises a multiplexer configured to combine encoded bitstreams from the plurality of encoders based on a control signal from the global rate controller.

5. The apparatus of claim 1, wherein the global rate controller comprises a model output buffer, wherein a level of the model output buffer is updated in a first direction based on sizes of encoded coding units received from the plurality of encoders and is updated in a second direction based on a target constant bitrate output.

6. The apparatus of claim 5, wherein the target constant bitrate is equal to a constant bitrate of the communication link.

7. The apparatus of claim 5, wherein the global rate controller is further configured to estimate a future level of the model output buffer based on estimated coded sizes of the buffered respective coding units.

8. The apparatus of claim 7, wherein the global rate controller is further configured to select the quality parameter having the value based on the estimated future level of the model output buffer.

9. The apparatus of claim 8, wherein the global rate controller is configured to adjust the value of the quality parameter responsive to the estimated future level of the model output buffer falling outside a target area.

10. The apparatus of claim 9, wherein the target area is greater than or equal to 65 percent of a size of the model output buffer and less than or equal to 95 percent of the size of the model output buffer.

11. The apparatus of claim 1, wherein the global rate controller further comprises a plurality of analyzers, wherein an analyzer of the plurality of analyzers is configured to receive the buffered coding unit, the analyzer further configured to generate base statistical information associated with the buffered coding unit based on complexity of the buffered coding unit, the analyzer further configured to provide the base statistical information and the buffered coding unit at an output.

12. The apparatus of claim 11, wherein the global rate controller further comprises a lookahead buffer configured to receive and store respective base statistical information and respective buffered coding units from the plurality of analyzers, wherein the global rate controller is configured to retrieve the base statistical information from the look ahead buffer, wherein the estimated respective size of the buffered coding unit is based on the base statistical information.

13. The apparatus of claim 12, wherein statmux system further comprises a plurality of delay buffers, wherein a delay buffer of the plurality of delay buffers is coupled to an input of a respective encoder of the plurality of encoders, wherein a length of the delay buffers is equal to a length of the lookahead buffer.

14. The apparatus of claim 12, wherein a length of the lookahead buffer is equal to at least one of a length of a virtual buffer verifier of the respective encoder, an intra-frame period of the channel, or one second.

15. The apparatus of claim 12, wherein the global rate controller is further configured to update the value of the quality parameter at a rate that is at least as great as a highest coding unit rate of the plurality of channels.

16. The apparatus of claim 11, wherein the analyzer includes a first pass encoder configured to encode the buffered coding unit, wherein the analyzer configured to generate the base statistical information is based on the encoded buffered coding unit from the first pass encoder.

17. The apparatus of claim 16, wherein the first pass encoder is configured to encode the buffered frame based on at least one of an internal constant bitrate control, the value of the quality parameter provided by the global rate controller, or a fixed value quality parameter.

18. A non-transitory computer-readable medium encoded with instructions comprising instructions that, when executed by one or more processing units, cause the one or more processing units to:
estimate a level of an output buffer based on buffered coding units received from a plurality of channels; and
provide a quality parameter to a plurality of encoders, wherein the quality parameter has a value based on the estimated future level of the output buffer.

19. The non-transitory computer-readable medium of claim 18, wherein the instructions further comprise instructions that when executed by one or more processing units, cause the one or more processing units to:
provide a first quality parameter having a first value to a first encoder of the plurality of encoders; and
provide a second quality parameter having a second value to a second encoder of the plurality of encoders.

20. The non-transitory computer-readable medium of claim 19, wherein the instructions further comprise instructions that, when executed by the one or more processing units, cause the one or more processing units to estimate coded sizes of the buffered coding units received from the plurality of channels, wherein the estimated future level of the output buffer is based on the estimated coded sizes of the buffered coding units.

21. The non-transitory computer-readable medium of claim 20, wherein the instructions further comprise instructions that, when executed by the one or more processing units, cause the one or more processing units to receive statistical information from each of the plurality of encoders based on a respective encoded coding unit, wherein the estimated coded sizes of the buffered coding units is based on respective statistical information of an associated channel of the plurality of channels.

22. The non-transitory computer-readable medium of claim 19, wherein a buffered coding unit comprises a buffered frame of a channel of the plurality of channels.

23. A method, comprising:
buffering respective coding units from each of a plurality of channels using a global rate controller;
estimating coded sizes of each of the buffered respective coding units from each of the plurality of channels based on statistical information; and
providing a quality parameter to a plurality of encoders having a value based on the estimated coded sizes of the buffered coding units.

24. The method of claim 23, wherein providing the quality parameter to the plurality of encoders having the value based on the estimated coded sizes of the buffered coding units comprises:
modeling a level of an output buffer using the global rate controller based on sizes of encoded coding units received from a plurality of encoders;
predicting a future level of the model output buffer based on the statistical information and the modeled level of the output buffer; and
adjusting the value of the quality parameter based on the future level of the output buffer.

25. The method of claim 24, wherein predicting the future level of the model output buffer comprises, starting with the modeled level of the model output buffer as the future level:
changing the future level in a first direction at a target constant bitrate output of the output buffer; and
changing the future level in a second direction based on estimated coded sizes of the buffered coding units.

26. The method of claim 24, wherein predicting the future level of the model output buffer comprises, responsive to detecting the future level exceeds a limit of the output buffer, performing at least one of:
adjusting the quality parameter to prevent the estimated future level from exceeding the limit of the output buffer; or
adjusting the quality parameter to delay a time at which the future level is predicted to exceed the limit of the output buffer.

27. The method of claim 23, further comprising determining the statistical information associated with each of the buffered respective coding units.

28. The method of claim 27, wherein determining the statistical information associated with each of the buffered respective coding units comprises:
detecting respective complexity information associated with each of the buffered respective coding units; and
detecting scene change information associated with each of the buffered respective coding units.

29. The method of claim 28, further comprising receiving respective additional statistical information from each of the plurality of encoders based on a respective encoded frame, wherein, for buffered frames of a same scene as the respective encoded frame determined from the scene change information, estimating coded sizes of each of the buffered respective coding units from each of the plurality of channels is further based on the respective encoded statistical information, and wherein, for buffered frames of a different scene than the respective encoded frame determined from the scene change information, estimating coded sizes of each of the buffered respective coding units from each of the plurality of channels is further based on default encoded statistical information:
